(19) United States
(12) Patent Application Publication
(10) Pub. No.: US 2013/0198111 A1
(43) Pub. Date: Aug. 1, 2013

(54) COMPUTER SYSTEM AND METHOD FOR PRODUCT ALLOCATION VISUALIZATION

(71) Applicant: Northwestern Mutual Life Insurance Company, Milwaukee, WI (US)

(72) Inventors: Angela M. DiCastri, Pewaukee, WI (US); Ronald C. Nelson, Whitefish Bay, WI (US); Peter K. Richardson, Fox Point, WI (US); Rebekah B. Barsch, Cedarburg, WI (US); Greg R. Steinbrenner, Thiensville, WI (US)

(73) Assignee: NORTHWESTERN MUTUAL LIFE INSURANCE COMAPNY, Milwaukee, WI (US)

(21) Appl. No.: 13/826,334

(22) Filed: Mar. 14, 2013

Related U.S. Application Data
(63) Continuation-in-part of application No. 13/362,865, filed on Jan. 31, 2012.
(60) Provisional application No. 61/583,287, filed on Jan. 5, 2012.

(51) Int. Cl. G06Q 40/06

(52) U.S. Cl. CPC G06Q 40/06
USPC 705/36 R

(57) ABSTRACT

Information is received regarding retirement assets to be invested by a retiree planning for retirement. Based on the information, a plurality of product allocation options are selected to be presented to the retiree. The product allocations comprise different allocations of the retirement assets to different types of products. A depiction is generated that simultaneously shows the plurality of product allocation options. The depiction compares income predicted to be derived from each of the plurality of product allocation options.

### CROSS-REFERENCE TO RELATED PATENT APPLICATIONS

This application is a continuation-in-part of U.S. Ser. No. 13/362,865, filed Jan. 31, 2012, which claims the benefit of U.S. Prov. No. 61/583,287, filed Jan. 5, 2012, both of which are hereby incorporated by reference in their entirety.

### BACKGROUND

Individuals often desire to achieve financial security in retirement. To do so, such individuals may attempt to manage various risks. For example, individuals may attempt to manage longevity risk (i.e., the risk associated with living longer than their predicted life expectancy based on actuarial tables), market risk (i.e., the risk associated with the volatility of investment markets), health care risk (i.e., the risk associated with having unexpected medical costs impact retirement income and savings), long term care risk (i.e., the risk associated with having long term care costs impact retirement income and savings), legacy risk (i.e., the risk associated with outliving assets and not being able to leave a legacy to beneficiaries), inflation risk (i.e., the risk associated with reduced purchasing power due to inflation), and tax risk (i.e., the risk associated with tax law changes impacting income and liquidation strategies). An ongoing need exists for tools that help such individuals select between retirement options that are designed to potentially address one or more of such risks.

### SUMMARY

According to an example embodiment, information is received regarding retirement assets to be invested by a retiree planning for retirement. Based on the information, a plurality of product allocation options are selected to be presented to the retiree. The product allocations comprise different allocations of the retirement assets to different types of products. One or more depictions is generated showing predicted income for the retiree during a plurality of different phases of retirement. The one or more depictions include a depiction is generated that simultaneously shows the plurality of product allocation options. The depiction compares income predicted to be derived from each of the plurality of product allocation options.

According to an example embodiment, information is received regarding retirement assets to be invested by a retiree planning for retirement. Based on the information, a plurality of product allocation options are selected to be presented to the retiree. The product allocations comprise different allocations of the retirement assets to different types of products. A depiction is generated that simultaneously shows the plurality of product allocation options. The depiction compares income predicted to be derived from each of the plurality of product allocation options. For each of the plurality of product allocation options, a range of incomes is shown.

### BRIEF DESCRIPTION OF THE DRAWINGS

FIG. 1 is a data entry screen used to collect information regarding an individual planning for retirement according to an example embodiment.

FIG. 2 is a screen summarizing the data entered in the data entry screen of FIG. 1 according to an example embodiment.

FIG. 3 is an options comparison display screen that provides information about various product allocation options according to an example embodiment.

FIG. 4 is a display screen that summarizes projected retirement income under the product allocation options shown in the display screen of FIG. 3 according to an example embodiment.

FIG. 5 is a display screen that provides asset allocation recommendations according to an example embodiment.

FIG. 6 is a glossary screen providing additional information according to an example embodiment.

FIG. 7 is a screen summarizing data entered in the data entry screen of FIG. 1 according to an example embodiment.

FIG. 8 is an options comparison display screen that provides information about various product allocation options according to an example embodiment.

FIG. 9 is a display screen that summarizes projected retirement assets under the product allocation options shown in the display screen of FIG. 8 according to an example embodiment.

FIG. 10 is a display screen that summarizes projected retirement income under the product allocation options shown in the display screen of FIG. 8 according to an example embodiment.

FIG. 11 shows an example of a hardware components of a computer system that generates that screens shown in FIGS. 1-10 according to an example embodiment.

FIG. 12 shows an example of an overall process implemented by the computer system of FIG. 11.

FIG. 13 is an options comparison display screen that provides information about various product allocation options according to an example embodiment.

FIGS. 14-15 are display screens that summarize projected retirement income under the product allocation options shown in the display screen of FIG. 3 according to an example embodiment.

### DETAILED DESCRIPTION OF EXAMPLE EMBODIMENTS

Referring now to the Figures, a computer system and method for product allocation modeling are shown. The computer system may be used in connection with individuals planning for or living in retirement. Computerized modeling may be performed to model potential results arising from different allocations of the retiree's retirement assets to different types of products. In various example embodiments, the retiree may be provided with multiple potential product allocations. The options may be presented simultaneously, e.g., in a side by side fashion. The allocations may include both annuity and non-annuity products. In one embodiment, at least one of the options contains an annuity product and at least one of the options does not contain any annuity products. The retiree may also be presented with corresponding options relating to annual consumption amounts. The options may be keyed to a specific probability of success and to a specific legacy goal.

Herein, the term “retiree” is used to refer to any individual or individuals (e.g., a couple) planning for retirement (i.e., regardless whether that individual is already retired). A retiree may plan for retirement alone or with the assistance of a third party, such as a financial planner, investment adviser, other representative of a financial services company, and so on.

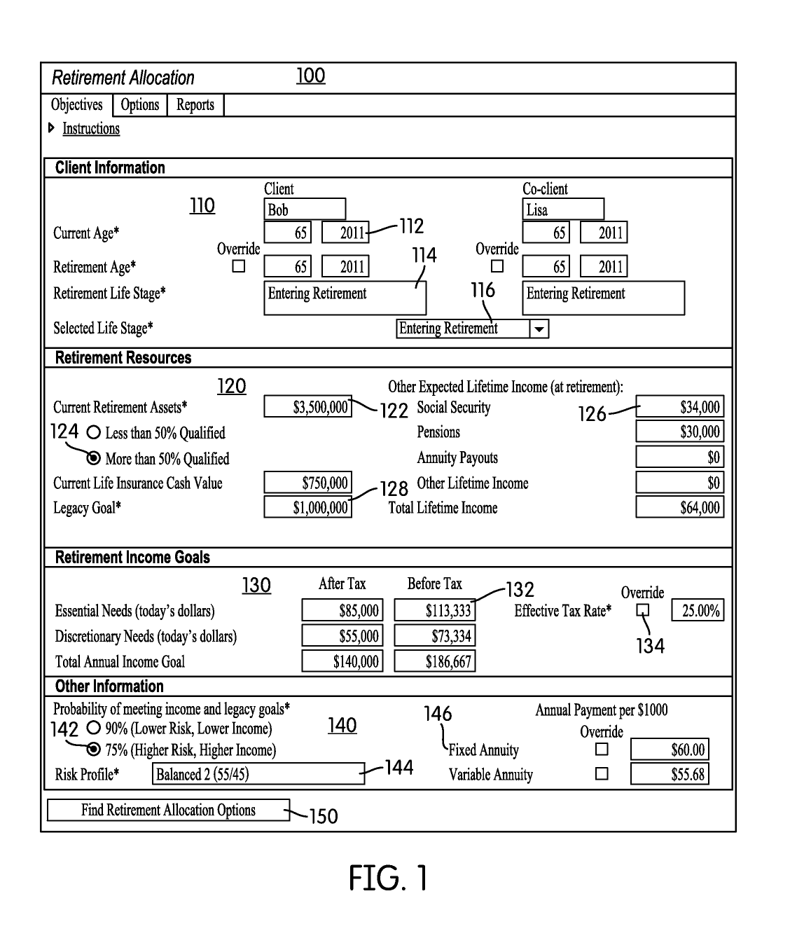

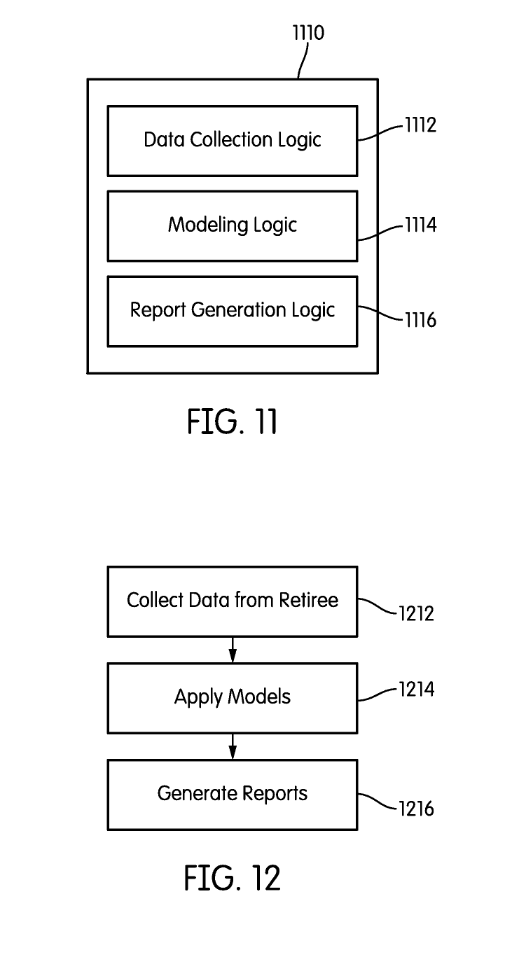

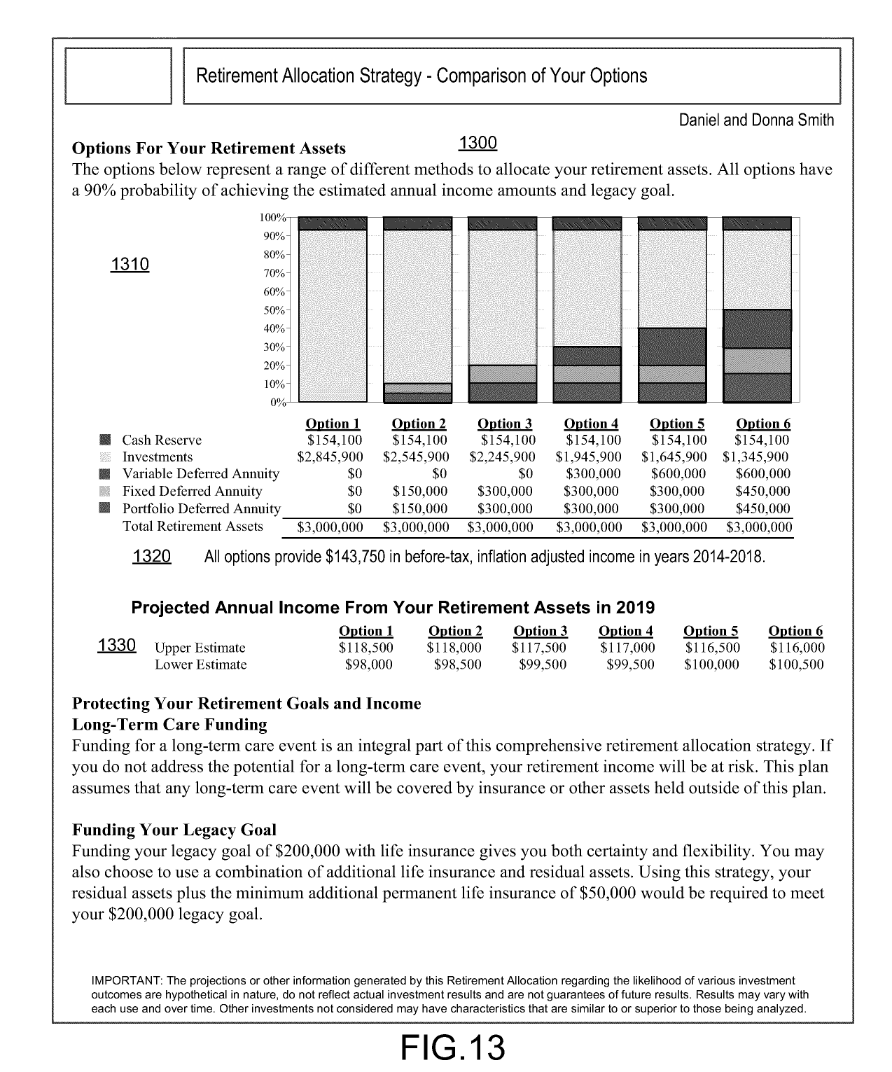

FIGS. 1-10 show an example of a graphical user interface including display pages 100-1000 generated by a computer system 1110. FIG. 11 shows an example of hardware components of the computer system 1110. FIG. 12 shows an example of an overall process 1200 implemented by the computer system. The techniques described herein may be used to provide systems that are made accessible to financial planners, investment advisers and other third parties that may assist a retiree with planning for retiree. In other embodiments, the techniques described herein may be used to provide systems that are made accessible directly to retirees (e.g., via financial planning tools offered via a website).

Referring first to FIG. 1, a data entry screen is shown that includes display areas 110-140. Although the example shown in FIGS. 1-10 relates to a couple, as will be appreciated, system 1110 may also be used in the context of single individuals. Display area 110 contains fields 112 configured to receive information about the retiree's current ages and retirement ages. As a default, the system 1110 assumes the retiree will retire at age 65, however, this assumption can be overridden.

Field 114 shows the retiree's life stage. In an example embodiment, retirees are categorized according to their life stage and the system 1110 operates differently depending on the life stage of the retiree. In an example embodiment, if the retiree is within 15 years of retirement the retiree is considered to be in the “approaching retirement” life stage, if the retiree is within 3 years of retirement the retiree is considered to be in the “entering retirement” life stage, and if the retiree has retired or is over age 70 the retiree is considered to be in the “living in retirement” life stage. In other embodiments, other age thresholds may be used. Variations may exist in the information that is collected from and/or presented to the retiree. In different life stages, different decisions may be made regarding how to allocate assets and whether to purchase products such as long term care insurance. Field 114 shows the life stage that is selected by system 1110 based upon the current age and desired retirement age of the retiree. As shown by field 116, the categorization made by system 1110 may also be overridden. The answer provided in field 116 may be toggled to produce plans for different life stages (e.g., for borderline retirees that are transitioning from one life stage to another).

Display area 120 includes fields 122 configured to receive information about the retiree's retirement resources. In example embodiments, such assets may include assets that are available for retirement, but may not necessarily be all of the retiree's assets. For example, such assets may not include 529 plan accounts, funds for legacy goals, assets in a trust where principal is not accessible, or value of a residence. The value of existing deferred annuities may be included in current retirement assets. Field 124 receives a selection of “Less than or More than 50% Qualified”. For the purpose of the qualified/non-qualified asset mix here, all tax-advantaged assets (those that are tax-free, tax-deductible or tax-deferred) are considered “qualified” assets. For example, all deferred annuities are considered in the qualified category when it comes to the qualified/non-qualified asset mix. Fields 126 may be configured to receive information about other expected annual lifetime income, such as Social Security, pensions, annuity payouts or other guaranteed income streams. The amounts may be entered as income received at retirement using “at retirement” valuation before reducing for taxes.

Display area 120 also includes field 128 configured to receive a legacy goal. The legacy goal is a dollar amount that the retiree wishes to pass on as a legacy to beneficiaries (e.g., heirs or charities). In an example embodiment, the legacy goal is a fixed number (i.e., does not increase or decrease according to the predicted performance of investments under different product allocations). In an example embodiment, the amount that is entered for the legacy goal is an amount that is currently not fully covered through the use of permanent life insurance or other non-retirement assets. If the retiree has sufficient permanent insurance or other non-retirement assets to cover the full legacy goal, then an amount of zero may be entered into field 128. Assuming a non-zero amount is entered, this amount is used to determine the optimal amount of new insurance coverage that is needed to coordinate with residual assets (after applicable taxes).

Display area 130 includes fields 132 configured to receive information about the retiree's essential and/or discretionary needs in today's after-tax dollars. In an example embodiment, essential needs includes income for food, housing, long term care insurance premiums, and health insurance premiums. In field 134, an effective tax rate on income may be entered to gross up these amounts entered in fields 132.

Display area 140 includes field 142 configured to receive a probability percent of meeting income and legacy goals. In an example embodiment, the retiree is provided with an option to select one of multiple probabilities of success (e.g., an option to select between a 90% and a 75% probability of success). Hence, the retiree may be provided with the ability to select whether to be more conservative or more aggressive in the retiree's assumptions regarding probability of success. As will be appreciated, a more aggressive retiree may be willing to accept more risk in hopes of greater investment returns and higher income, whereas a more risk averse retiree may be willing to accept lower potential income in order to reduce risk. A 90% probability of success may mean that the retiree has a 90% chance of meeting both the specified legacy goal and the specified income goal. A “failure” may mean that the legacy goal is not achieved or that the income goal is not achieved. Failing to achieve these goals by any amount may constitute a failure. Hence, such failure does not necessarily mean that the retiree would completely run out of funds. Such failure may mean that the retiree must live on slightly less income than hoped for, or that they are not able to leave their beneficiaries as much money as desired. A probability of 90% or 75% can be used for all life stages. While two probabilities are shown, different probabilities or a different number of probabilities may also be employed. The answer provided in field 142 may be toggled to produce plans at both probabilities. In field 144, a risk profile is shown that populates based on information provided by the retiree.

Field 146 automatically populates with current annuity rates, which may be periodically updated. The values in field 146 may also be overridden to better reflect current annuitization rates in model options. After the information has been entered, button 150 may be pressed to cause product allocation models to be generated.

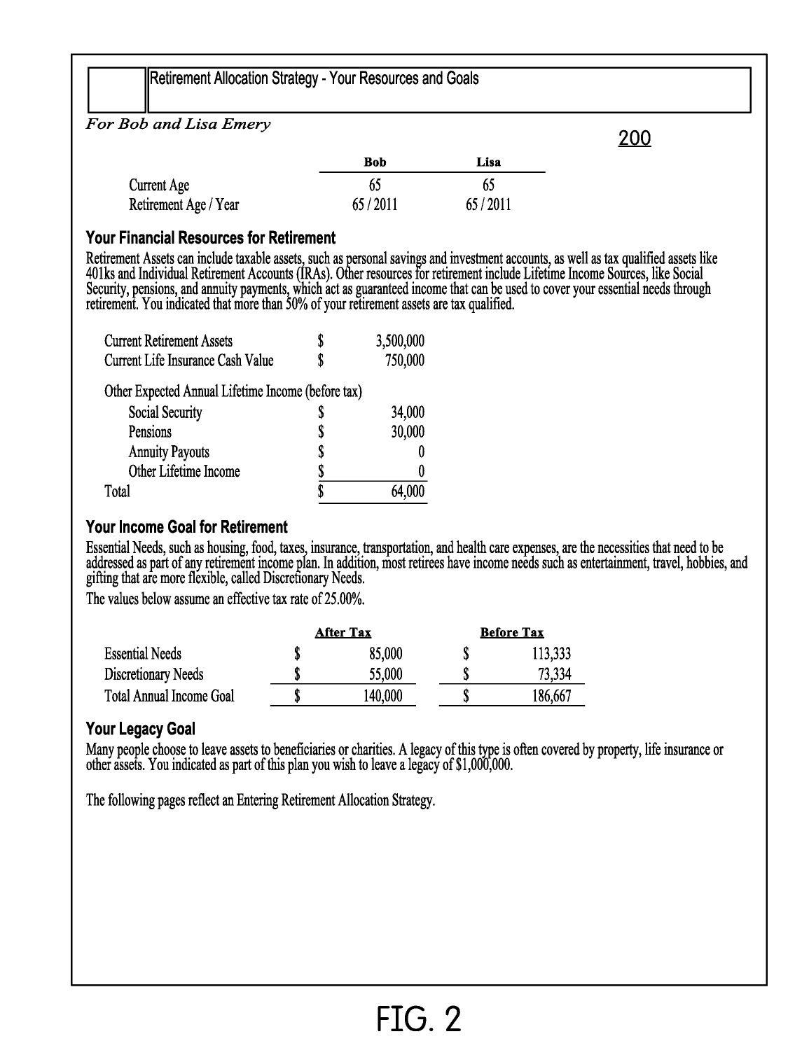

Referring now to FIGS. 2-6, example report screens are shown that may be provided to a retiree. In FIGS. 2-6, the report screens are shown for a retiree that is in the entering retirement life stage.

Referring first to FIG. 2, FIG. 2 shows a display screen 200 summarizing the retiree's resources and goals as entered in the display screen 100. Screen 200 shows the retirement income needs in both today's after-tax and before-tax dollars.

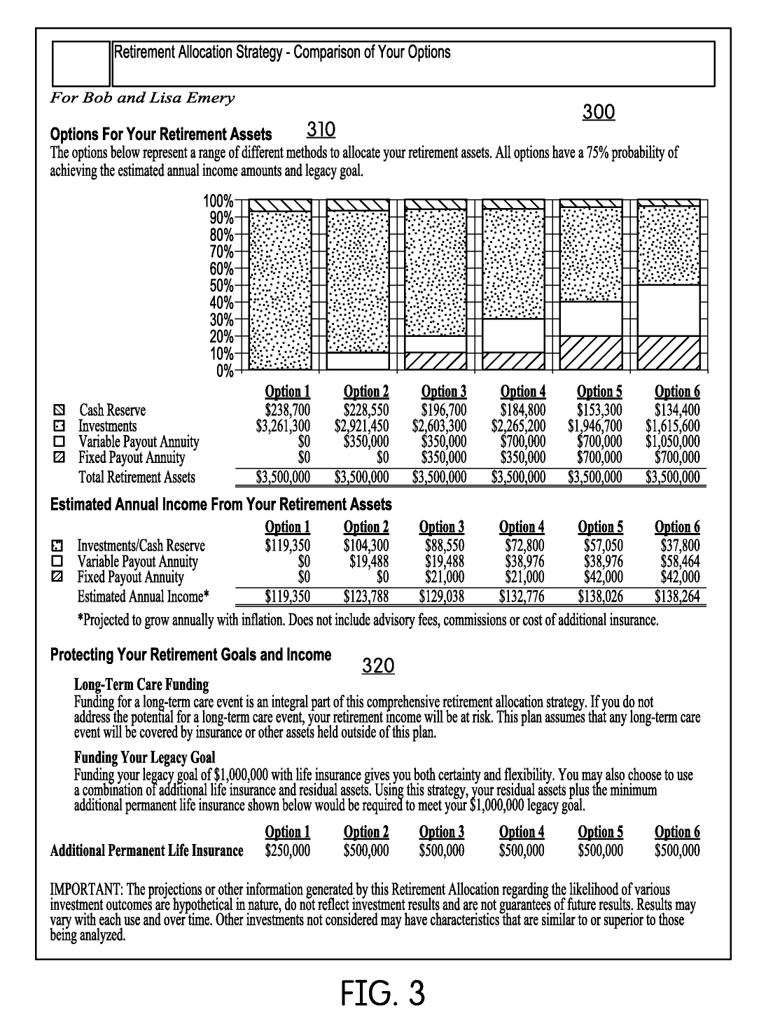

Referring next to FIG. 3, FIG. 3 shows an options comparison display screen 300 that provides information about various product allocation options available to the retiree. Display area 310 presents recommended product allocation options. The various options may include combinations of one or more of annuity assets (e.g., variable payout annuities, fixed payout annuities, etc.) and non-annuity assets (e.g., investments, cash reserves, etc.). While, in FIG. 3, six options are presented, fewer or more options may also be presented. In one embodiment, regardless how many options are presented, at least one of the options contains an annuity product and at least one of the options does not contain any annuity products. For retirees in the entering retirement life stage and the living in retirement life stage, recommendations for a cash reserve account may be included in the models.

System 1110 compares the equity allocation of all of the product allocation options with the retiree's risk profile. The equity allocations each have a risk profile that is either the same as or more conservative to the risk profile of the retiree. If this is not the case, the given option is not presented on the display screen 300. In an example embodiment, system 1110 determines whether a predetermined number of options (e.g., three) are available for presentation to the retiree and, if so, then the options are presented. If less than the predetermined number of options are available, then display screen 300 is not generated. In one embodiment, at least one of the options presented comprises 0% annuities.

In an example embodiment, the income shown in FIG. 3 is inflation-adjusted. For example, under Option 6 a total estimated annual income of $138,264 is shown. Over time, the dollar amount actually received by the retiree will increase in accordance with inflation.

In display area 320, information is provided about protecting retirement goals and income. For example, information may be provided explaining how life insurance and long-term care insurance may be used to address risks and how they could be used to help achieve retirement goals.

With regard to life insurance, as will be appreciated, the legacy goal may be met in a variety of ways. For example, the retiree may purchase life insurance. If the amount of the insurance policy is equal to the amount of the legacy goal, the retiree may have a 100% probability of the legacy goal being met. If the amount of the insurance policy is less than the amount of the legacy goal, then the shortfall may be covered by residual assets, and subject to the 75% or 90% probability. If life insurance is not purchased, then the entirety of the legacy goal may be covered by residual assets, and subject to the 75% or 90% probability.

With regard to long term care insurance, as will be appreciated, long term care insurance may be used to increase the amount of income available to the retiree at the 75% and 90% probability levels. Accordingly, in an example embodiment, the product allocation options that are presented may each assume that the retiree has long term care insurance or that the retiree has other assets that can be used to cover a long term care event. If the retiree does not already have long term care insurance or such other assets, then part of the income under the plan is used to pay for long term care insurance. (As previously indicated, the essential needs income entered in field 132 may include income designated for spending on long term care insurance.)

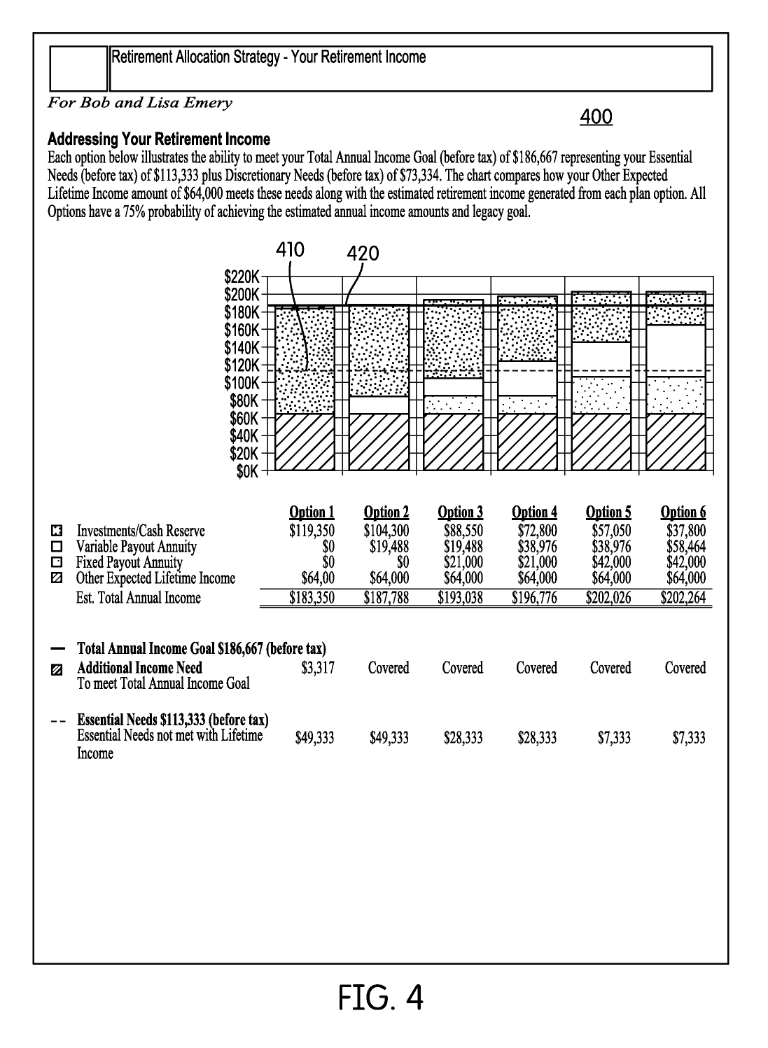

Referring now to FIG. 4, FIG. 4 shows a display screen 400 summarizing projected retirement income of the retiree under the product allocation options shown in FIG. 3. Screen 400 provides a summary of the estimated income a retiree would receive in retirement based on implementation of each option. Line 410 indicates the level of income needed to support the essential needs of the retiree. Line 410 may be helpful when modeling a product allocation option that matches essential needs to guaranteed income sources. It may be noted that, in FIG. 4, income derived from guaranteed income sources (e.g., fixed payout annuities, social security, pensions, and other similarly guaranteed sources of income) is shown at the bottom of each of the bars. Hence, line 410 provides a comparison of the essential needs income goal of the retiree with income derived from such guaranteed income sources.

Line 420 shows the total annual income goal (including both essential needs and discretionary needs). In an example embodiment, the top of each bar represents the estimated total income (before tax) that the retiree would need to meet his or her desired lifestyle. If there is a shortfall, then a top portion of the bar extending between this total to the actual amount of income may be shown, e.g., in red. In other words, if there is any red that appears on this graph, it may represent that the option does not generate enough income to meet their total need for income. In another embodiment, the bar is made shorter and does not extend all the way to line 420 in the event of a shortfall.

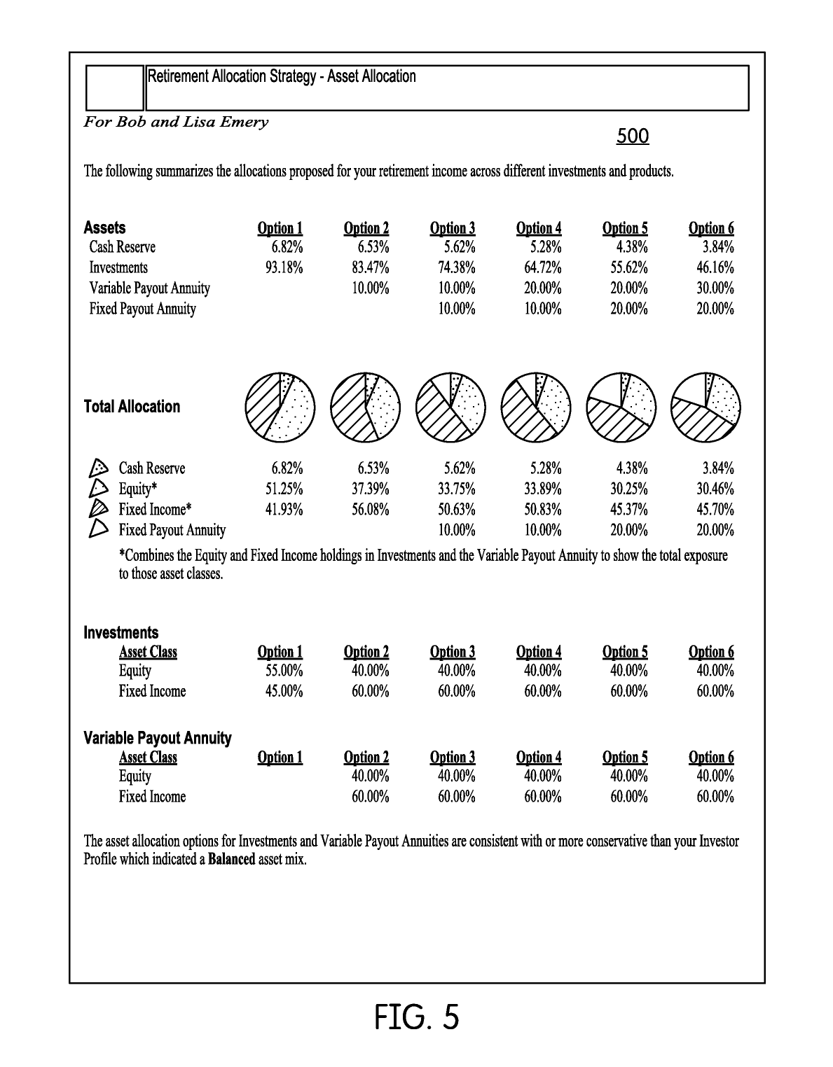

Referring now to FIG. 5, FIG. 5 shows a display screen 500 providing asset allocation recommendations for both investments and variable annuities for each option. The results are consistent with (or more conservative than) the risk profile of the retiree, as previously described.

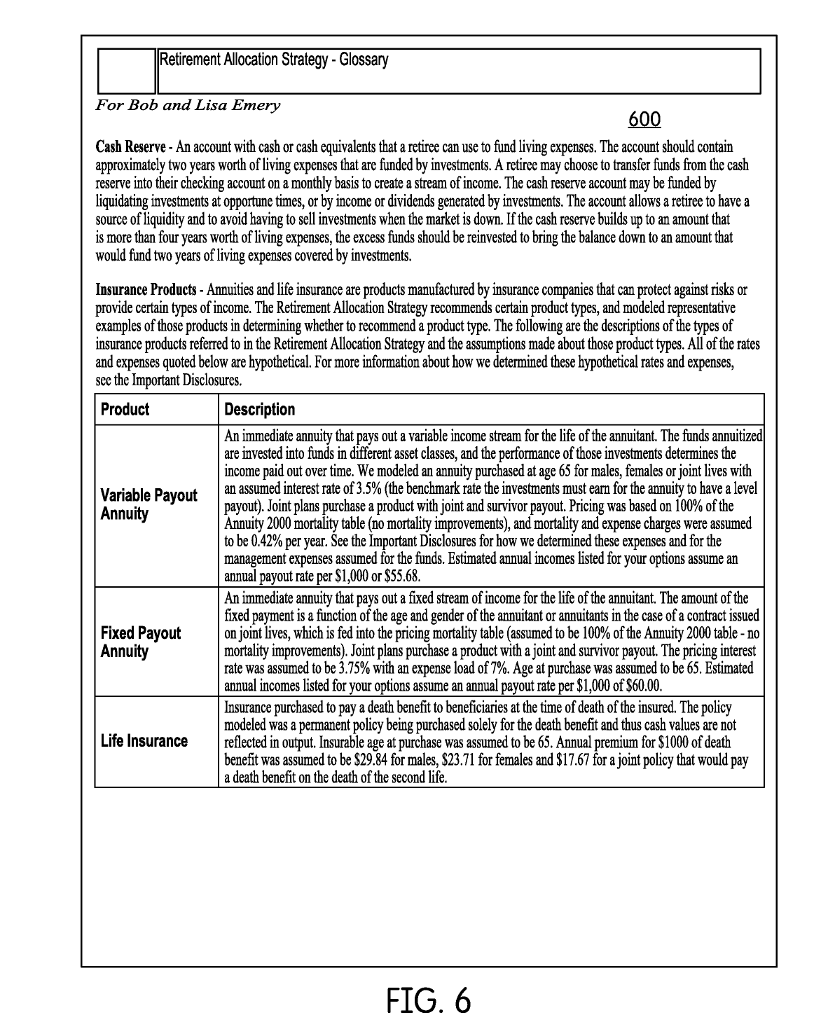

Referring now to FIG. 6, FIG. 6 shows a glossary output display screen 600 providing additional information for the retiree to consider. In an example embodiment, the language that is presented adjusts to the appropriate life stage of the retiree.

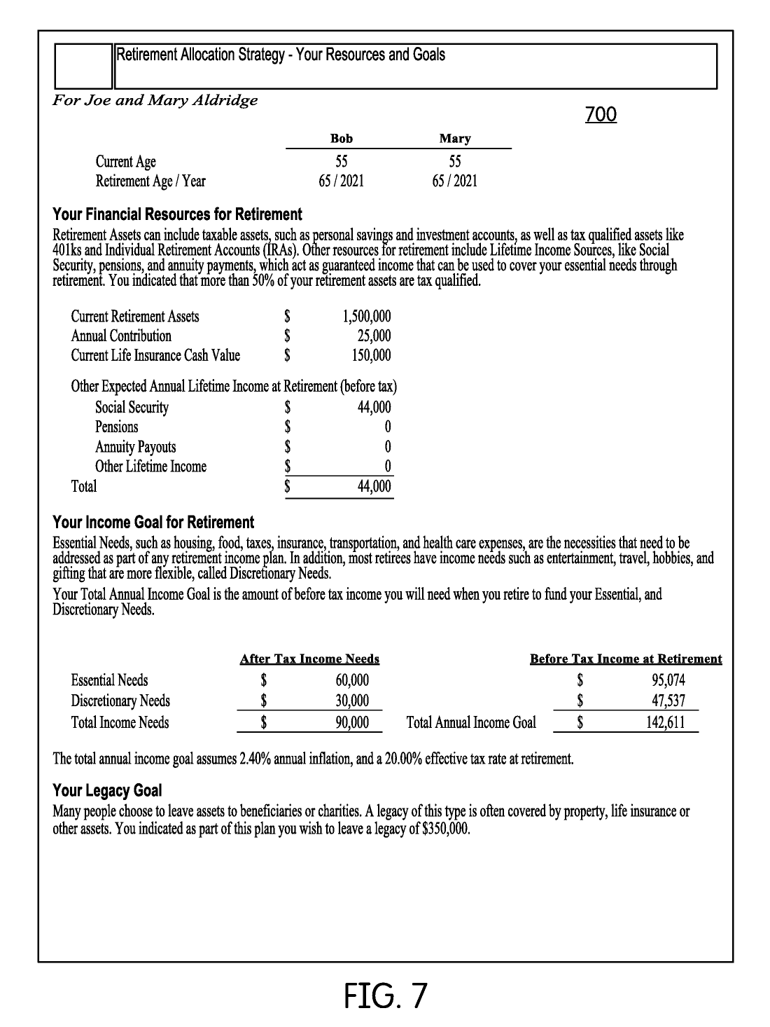

Referring now to FIGS. 7-10, FIGS. 7-10 are similar to FIGS. 2-4 except that they are provided in the context of retirees that are in other life stages. Referring first to FIG. 7, FIG. 7 shows a display screen 700 summarizing the retiree's resources and goals, similar to FIG. 2. In FIG. 7, the retirees are age 55 and are in the approaching retirement life stage. Display screen 700 shows an annual contribution to a retirement plan. Additionally, display screen 700 also shows income needs in today's after-tax dollars and the need at retirement in before-tax dollars, while the display screen 200 shows the retirement income needs in both today's after-tax and before-tax dollars. In an example embodiment, in the living in retirement version of this screen, the “Your Legacy Goal” section is not shown on the assumption that legacy goals are funded with permanent life insurance and/or enough residual assets.

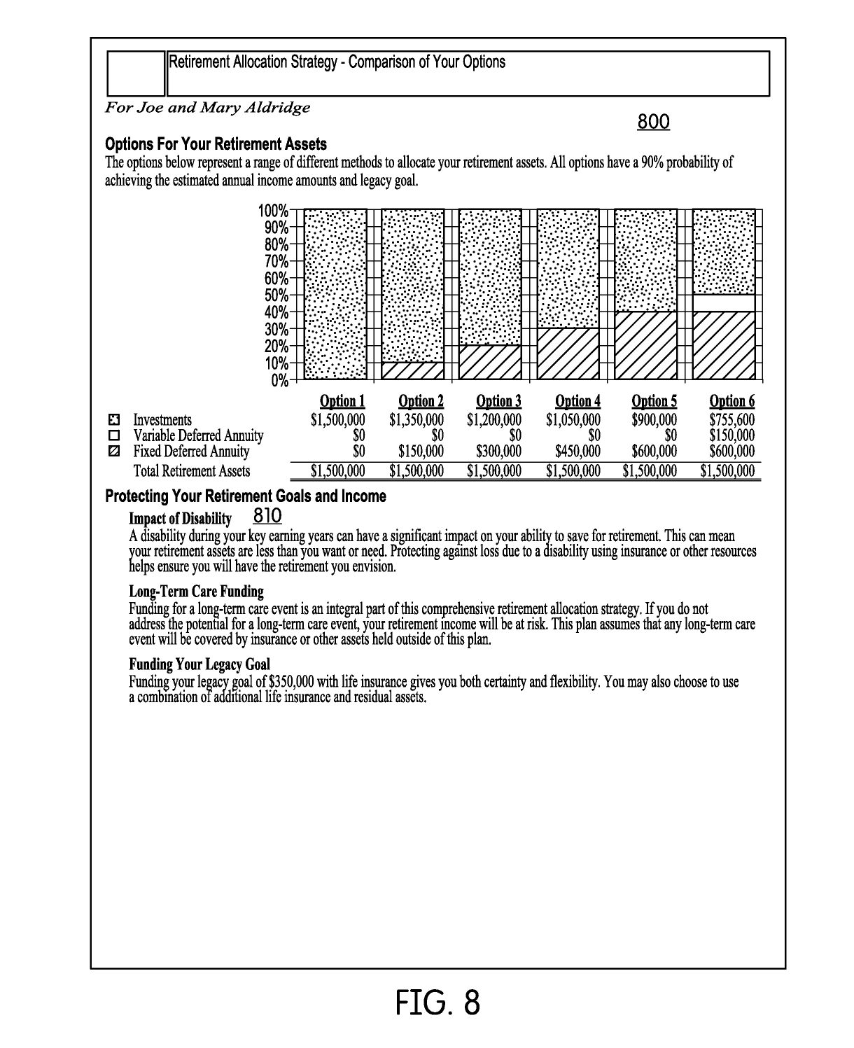

Referring now to FIG. 8, FIG. 8 shows an options comparison display screen 800 that provides information about various product allocation options available to the retiree, similar to FIG. 3. For retirees in the approaching retirement life stage, the display screen adds a section on the impact of a disability. During the approaching life stage, it is assumed the retiree purchases disability insurance to ensure that assets will continue to accumulate in the event the retiree becomes disabled. The displays screen 800 also eliminates the information about the cash reserve, as the retiree will not be implementing the distribution strategy for some time. In an example embodiment, for retirees in the living in retirement life stage, the report does not include the “Funding Your Legacy Goals” section.

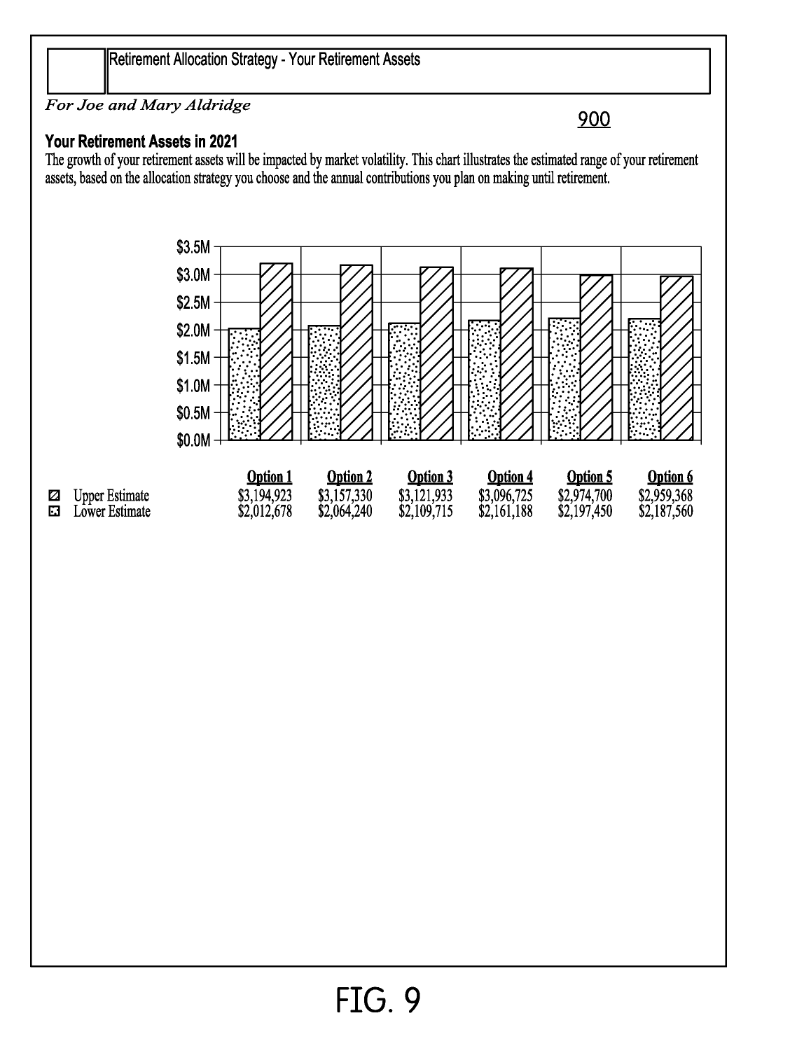

Referring now to FIG. 9, FIG. 9 shows a display screen 900 summarizing retirement assets at retirement under the product allocation options shown in FIG. 8. In an example embodiment, display screen 900 is generated only for retirees in the approaching retirement life stage. Display screen 900 shows the upper and lower estimates for their retirement assets, when they reach retirement, for all six allocation options. This helps the retiree understand the impact that optimally positioning their assets prior to retirement can have on retirement income.

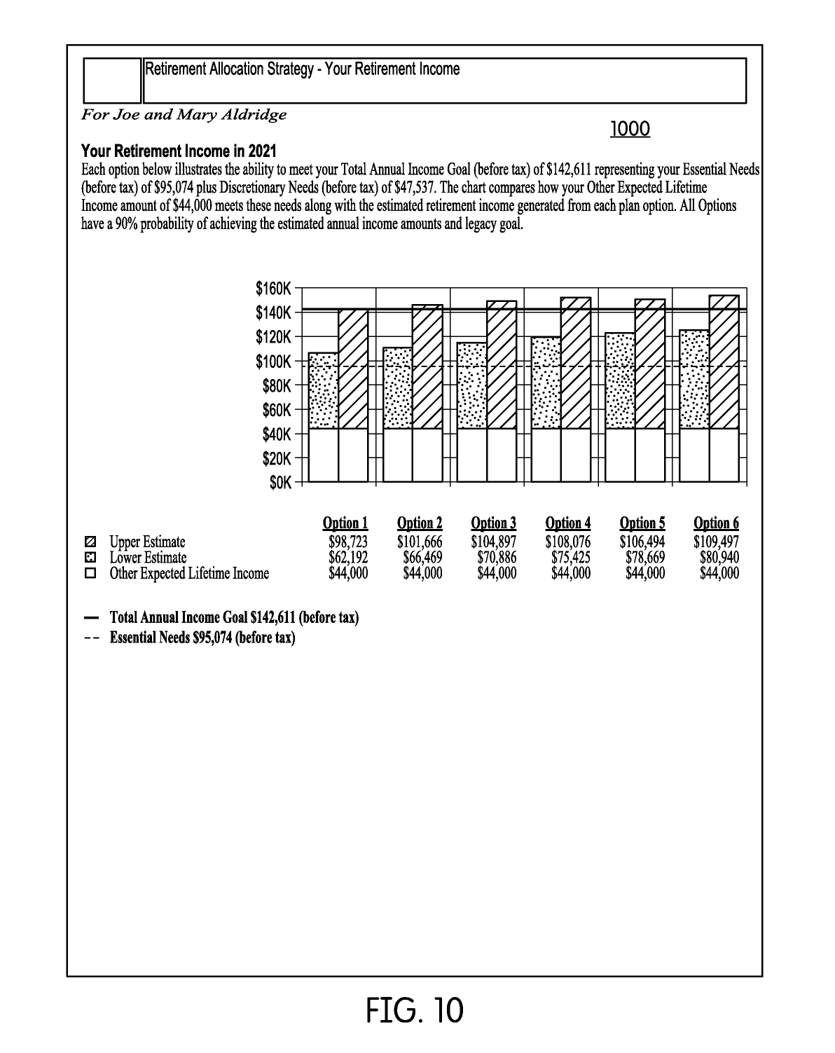

Referring now to FIG. 10, FIG. 10 shows a display screen 1000 summarizing retirement income under the product allocation options shown in FIG. 8. Upper and lower income estimates may be provided to help the retiree compare possible outcomes.

Referring now to FIGS. 11-12, a retirement planning system 1110 is shown in FIG. 11 and a retirement planning process is shown in FIG. 12. System 1110 may be implemented, for example, using a programmed computer (e.g., a desktop computer, laptop computer, etc.) provided with program modules including routines, programs, objects, components, data structures, etc. that perform particular tasks described herein.

Retirement planning system 1110 comprises data collection logic 1112, modeling logic 1114, and report generation logic 1116. Data collection logic 1112 is configured to receive input from the retiree (e.g., directly, by way of a financial planner or investment adviser, etc.) (FIG. 12, step 1212). Data collection logic 1112 may comprise logic such as that used to generate the screen display 100 shown in FIG. 1.

Modeling logic 1114 is used to process the data provided by the retiree and collected by data collection logic 1112. For example, modeling logic 1114 may be used to convert data provided by the user into data useable to generate the reports shown in FIGS. 2-10 (FIG. 12, step 1214). For example, modeling logic 114 may be configured to generate the product allocation options that are shown in FIGS. 2-10 based on the data provided by the retiree. Modeling logic 1114 is described in greater detail below.

Report generation logic 1116 is configured to generate reports that present output of modeling logic 1114 to the retiree (FIG. 12, step 1214). For example, report generation logic 1116 may be configured to generate reports such as those shown in FIGS. 2-10. Such reports may be presented to the retiree via a computer display screen, presented electronically via the internet, presented in hardcopy format using a printer, and so on.

An example embodiment of the modeling logic 1114 will now be described in greater detail, including a manner of constructing the modeling logic 1114. In an example embodiment, the modeling logic 1114 is constructed based on a set of retirement income distribution models that each focus on specific customer segment definitions (“customer segments”) of hypothetical retirees. Different customer segments are used for different segments of hypothetical retirees according to the hypothetical retiree's gender, age, financial assets, percent of assets that are non-qualified in nature, and social security income. An example of a customer segment may, for example, be “male, medium net worth [$500,000 in financial assets], non-qualified investment.” In an example embodiment, a limited number (e.g., less than 50, less then 20, etc.) of customer segments are defined. Additionally, the distribution models may also take into account a number of solution points that are defined by the combination of financial objectives that the hypothetical retiree is trying to achieve. An example of a solution point, may, for example, be “90% success rate—25% wealth transfer objective (i.e., 25% of the net worth is passed on as legacy to beneficiaries).” The term “success rate” is used interchangeably with the term “probability of success” for the purpose of the present invention. Again, a limited number (e.g., less than 20, less than 10, etc.) of solution points are defined.

For each hypothetical retiree, Monte Carlo simulations may be performed on numerous (e.g., 500 or greater, 1000 or greater, etc.) candidate model solutions each representing specific product allocations. For each candidate model solution, the Monte Carlo analysis may comprise numerous (e.g., 500 or greater, 1000 or greater, etc.) simulations of how the investments and other products in the candidate model solution would perform under randomly simulated scenarios. In an example embodiment, variables such as inflation, investment returns or losses, the risk of death during a given year, and the probability of having a long-term care event in any given year, etc., may be randomized during the simulations. Each simulation may thus produce an outcome which may be compared against the legacy goal of the hypothetical retiree and an annual consumption target. For purposes of conducting the simulations and creating the distribution models, the annual consumption target may be a number (representing annual consumption of the hypothetical retiree) that is adjusted upwardly/downwardly until a specified success rate is reached in the simulations.

For example, for a hypothetical retiree that is an affluent couple (having $1,000,000 in assets), that has a legacy goal of $250,000 (i.e., 25% of $1,000,000), and that desires a 90% success rate, the Monte Carlo analysis may test the candidate model solution to determine whether the candidate model solution is successful in meeting the annual consumption target and legacy goal in 450 (i.e., 90% of 500) of the total 500 simulations. If the candidate model solution is not successful at the specified success rate, then the annual consumption target may be increased or decreased (depending on whether the success rate was too high or too low) until the specified success rate is reached. While the annual consumption target is adjusted, the investment allocations within the candidate model solution may remain unchanged. This process may be performed for each candidate model solution until, for each candidate model solution, an annual consumption target is reached that results in the candidate model solution having the specified success rate. The candidate model solutions may then be then ranked according to the annual consumption target associated with each, and six model solutions may be selected from among the highest ranking candidate model solutions. A manual review of the candidate model solutions may also be performed to ensure that the certain candidate model solutions are considered to be an appropriate product allocation for a particular hypothetical retiree. Hence, the six candidate model solutions that are selected need not be the six highest ranking candidate model solutions. During this process, the legacy goal need not be factored into the calculations described above in ranking the candidate model solutions (e.g., as simulations are performed, the legacy goal may remain fixed at the amount specified by the hypothetical retiree).

In an example embodiment, the six candidate model solutions that are selected may be configured to have incrementally higher proportions of annuity products. Thus, in the example of FIG. 5, the candidate model solutions that are selected may comprise a high ranking candidate model solution with no annuity products, a high ranking candidate model solution with 10% annuity products, a high ranking candidate model solution with 20% annuity products, a high ranking candidate model solution with 30% annuity products, a high ranking candidate model solution with 40% annuity products, and a high ranking candidate model solution with 50% annuity products. Additionally, within the annuity products, as shown in FIG. 5, the annuity products may include different proportions of fixed payout annuities and variable payout annuities. The asset allocation within the investments (e.g., the allocation of funds as between mutual fund investments, bond investments, and so on) and within any variable payout annuities may also be varied in the different candidate model solutions to achieve different predicted outcomes.

The distribution models that are thereby developed may thus be incorporated into the modeling logic 1114 and stored in a database. Specifically, when the retiree provides information such as that set forth in FIG. 1, the retiree may be matched to the hypothetical retiree having the closest matching profile. Based on this information, the model solutions selected for that hypothetical retiree may be selected from the database and used to generate display screens such as those shown in FIGS. 2-10. The annual income of the retiree may be adjusted to reflect the actual amount of assets available for retirement. For example, if the hypothetical retiree having the closest matching profile has $500,000 in retirement assets, and the actual retiree has $600,000 in retirement assets, then the income computed for the hypothetical retiree may be adjusted upwardly (e.g., by 20%) to reflect the actual amount of assets available for retirement. In another example embodiment, the precise amount of the adjustment may reflect variations in product allocations and other parameters (and associated discrepancies in the income thereby generated) caused by the fact that $600,000 is invested and not $500,000.

As previously indicated, system 1110 may be implemented, for example, using a programmed computer (e.g., a desktop computer, laptop computer, etc.) provided with program modules including routines, programs, objects, components, data structures, etc. that perform particular tasks described herein. The logic 1112-1116 may therefore be implemented as program logic circuits that are stored on the non-transitory machine-readable storage media and that, when executed by processor(s) of computer(s), causes the processor(s) to perform the operations described herein. Planning system 1110 may be accessed locally or remotely (e.g., logic for planning system 1110 may be stored and accessed locally, or may be provided on a server and made available to a user remotely via a globally accessible public communication network, such as the Internet). System 1110 may further include network interface logic. For example, if system 1110 is implemented on a programmed computer, such interface logic may be used to communicate parameters of a retirement plan developed for a retiree to a server-based central repository via the communication network.

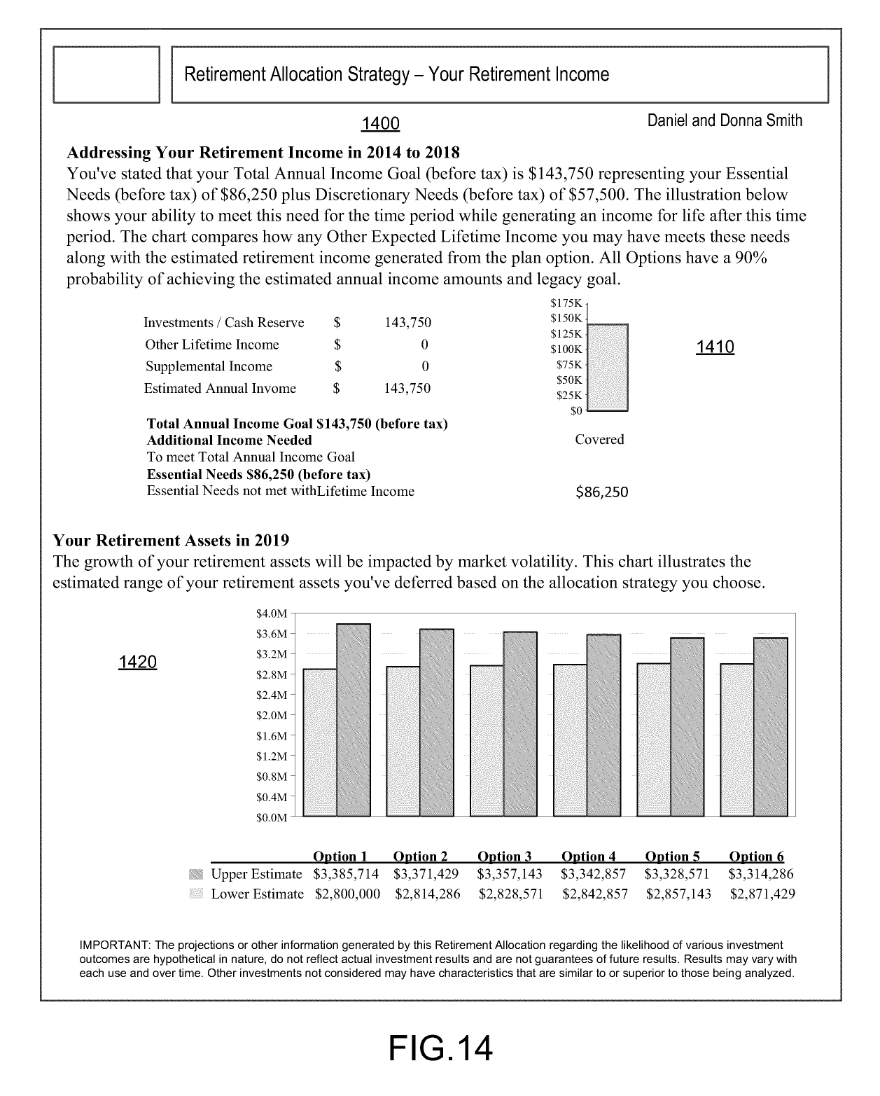

Referring now to FIGS. 13-15, FIGS. 13-15 show additional examples of report screens that may be generated by the computer system 1110. FIGS. 13-15 provide alternative embodiments of the report screens shown in FIGS. 3-4 discussed above. For simplicity, certain aspects of FIGS. 13-15 that are the same or similar to FIGS. 3-4 are not repeated below. As will be appreciated, the report screens of FIGS. 13-15 may be generated based on data received via the data entry screens described above.

In FIGS. 13-15, the period during which the retiree will be living in retirement is broken down into multiple phases and a retirement plan is developed that provides for different income levels for each of the phases. For example, a retiree may desire to have different levels of consumption during different phases of retirement (e.g., to allow for more travel during earlier years of retirement, to provide for more income during early years of retirement before social security payments start, etc.). In the example of FIG. 13-15, the period during which the retiree will be living in retirement is broken down into two phases, including a first phase from 2014-2018 and a second phase from 2019 and beyond. In other embodiments, the period during which the retiree will be living in retirement may be broken down into more than two phases.

To provide for different levels of income, the computer system 1110 may generate fields (not shown) in FIG. 1 configured to prompt the retiree to specify a desired level of income for one or more of the phases. For example, in the example of FIGS. 13-15, the retiree has specified that the retiree desires $143,750 in annual income during the first phase of retirement. The computer system 1110 then determines the amount of assets that are needed to achieve the desired level of income (e.g., $143,750) for the first phase. For example, if the retiree is permitted to specify an initial 5-yr phase which precedes the remainder of retirement, the modeling logic 1114 may generate additional sets of candidate model solutions focusing specifically on the initial 5-yr period for each of the customer segment definitions of hypothetical retirees. The model solutions may then be used to determine the amount of assets by working backwards from the desired level of income. The remaining assets that are not used for the first phase may then be used to fund the remainder of retirement. Again, the previously-discussed candidate model solutions may be used to determine what level of income such retirement assets are likely (e.g., with a 75% or 90% certainty) to produce. During retirement, at the end of the first phase (e.g., at the end of year 2018), any assets that are remaining are added to the other assets previously allocated to fund the second phase of retirement. In one embodiment, as will be described in greater detail below, because the amount of assets that will ultimately be remaining at the end of the first phase is not initially known when the retirement plan is created, and therefore the level of retirement assets available to fund the second phase of retirement is not initially known, the level of income during the second phase (and subsequent phases, if applicable) may be presented to the retiree as a range instead of as a single number. In other embodiments, the level of income during the additional phase(s) may be presented as a single number.

As another example, if the period during which the retiree will be living in retirement is broken down into four phases, then the retiree may be prompted to specify a desired level of income for each of the first three phases. The retiree may also be prompted to specify a probability of success for each of the phases in field 142 of FIG. 1 (e.g., 75% or 90%). In some embodiments, the same probability of success is used for each of the phases. In other embodiments, the probability of success may be different and the investor may be prompted to separately specify a probability of success for each phase. The computer system 1110 may then determine the amount of assets that are needed to achieve the desired level of income for each of the first three phases (i.e., a first amount for the first phase, a second amount for the second phase, and a third amount for the third phase). As will be appreciated, the level of income during the fourth phase is determined based on the remaining retirement assets and, hence, based on the level of income specified by the retiree during the first three phases. That is, for example, to the extent the retiree decides to receive more income during early phase(s) of retirement, that reduces the amount of assets available to fund retirement income during the final phase of retirement and therefore reduces the level of income during the final phase of retirement. As will be appreciated, rather than have the final phase of retirement be the phase for which the retiree does not specify a level of income, the computer system 1110 may be configured such that the retiree specifies a level of income for the final phase of retirement and does not specify a level of income for one of the earlier phases of retirement. During retirement, at the end of the first phase, any assets that are remaining are added to the other assets previously allocated to fund the second phase of retirement; at the end of the second phase, any assets that are remaining are added to the other assets previously allocated to fund the third phase of retirement; and at the end of the third phase, any assets that are remaining are added to the other assets previously allocated to fund the fourth phase of retirement.

Referring to FIGS. 13-15 in greater detail, FIG. 13 shows an options comparison display screen 1300 that provides information about various product allocation options available to the retiree. As in FIG. 3, display screen 1300 includes a display area 1310 that presents recommended product allocation options, and the various options may include combinations of one or more of annuity assets (e.g., variable payout annuities, fixed payout annuities, etc.) and non-annuity assets (e.g., investments, cash reserves, etc.).

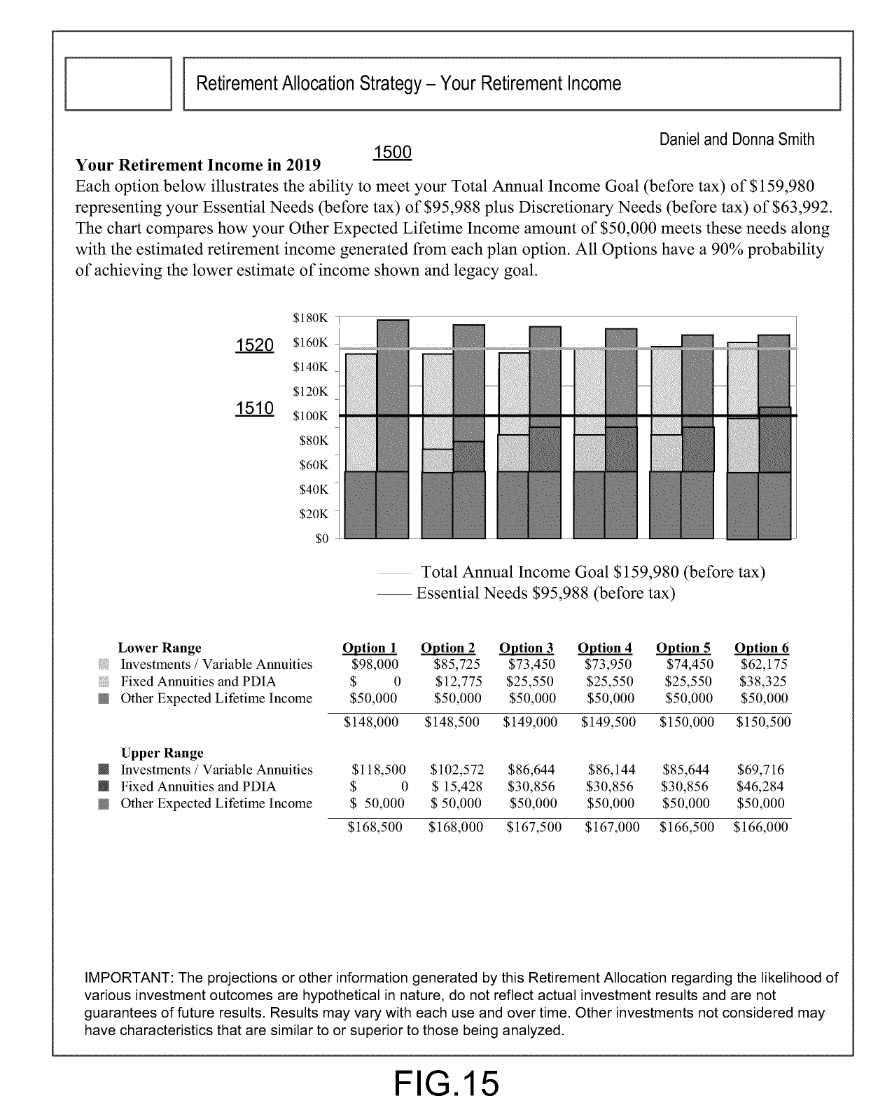

In FIG. 13, the retiree has specified that the retiree desires $143,750 in annual income during the first phase of retirement, as indicated in display area 1320. Display screen 1400 shown in FIG. 14 includes a display area that shows how income is derived and provides additional details. In one embodiment, the computer system 1110 configures the retirement plan to provide the level of income specified by the retiree (e.g., $143,750) even if investments do not perform as well as predicted. For example, if the investments perform poorly during the first phase of retirement, then the shortfall in income may be covered using retirement assets that were otherwise allocated for providing income during the second phase of retirement. Hence, the specified level of income during the first phase of retirement may be maintained in spite of poor investment performance, however, the amount of retirement assets available at the start of the second phase of retirement (and therefore the level of income available during the second phase of retirement) may be reduced. In other embodiments, the computer system 1110 may configure the retirement plan such that the level of income provided during the first phase may be different than the level of income specified by the retiree (e.g., $143,750), depending on the investment performance of the retirement assets of the retiree during the first phase of retirement. Hence, the specified level of income during the first phase of retirement may decline in the event of poor investment performance, however, the amount of retirement assets available at the start of the second phase of retirement may be maintained as specified.

Referring again to FIG. 13, display area 1330 shows predicted levels of income for the retiree during the second phase of retirement for various allocation options. As previously indicated, a range (e.g., upper estimate, lower estimate) may be given for the second phase of retirement to reflect the uncertainty associated with the investment performance of the retirement assets of the retiree during the first phase of retirement. In an example embodiment, the lower and upper estimates may each correspond to a different probability of success. That is, for example, the retiree may be relatively likely to receive at least the lower estimate of income, and may receive more (reflected by the upper estimate), although is less likely to do so. The range provided may therefore reflect a range of possibilities regarding how factors such as market volatility, longevity, inflation, and so on, may impact the retirement income of the retiree in the second (or subsequent) phase of retirement. Display area 1420 in FIG. 14 shows retirement assets of the retiree in the second phase of retirement. Again, for each of the product allocation options, a range is given. In one embodiment, the range is shown using an upper estimate and a lower estimate, each of which correspond to a different probability of success.

FIG. 15 shows a display screen 1500 summarizing projected retirement income of the retiree under the product allocation options shown in FIG. 13. Screen 1500 provides a summary of the estimated income a retiree would receive in retirement based on implementation of each option. Line 1510 indicates the level of income needed to support the essential needs of the retiree. Line 1510 may be helpful when modeling a product allocation option that matches essential needs to guaranteed income sources. It may be noted that, in FIG. 15, income derived from guaranteed income sources (e.g., fixed payout annuities, social security, pensions, and other similarly guaranteed sources of income) is shown at the bottom of each of the bars. Hence, line 1510 provides a comparison of the essential needs income goal of the retiree with income derived from such guaranteed income sources.

Line 1520 shows the total annual income goal (including both essential needs and discretionary needs). In one embodiment, if there is a shortfall, the bar does not extend all the way to line 1520. If any gap appears, that portion of the bar represents that the option does not generate enough income to meet their total need for income. In another example embodiment, the top of each bar represents the estimated total income (before tax) that the retiree would need to meet his or her desired lifestyle. If there is a shortfall, then a top portion of the bar extending between this total to the actual amount of income may be shown, e.g., in red. In other words, if any red appears, that portion of the bar represents that the option does not generate enough income to meet their total need for income.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising non-transitory machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, server systems, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include one or more general purpose computers including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

We claim:

1. A non-transitory computer-readable medium storing computer program code that, when executed by a computer, causes the computer to perform the operations of:
receiving information regarding retirement assets to be invested by a retiree planning for retirement;
selecting, based on the information received regarding retirement assets to be invested by the retiree, a plurality of product allocation options to present to the retiree, the product allocations comprising different allocations of the retirement assets to different types of products; and
generating a depiction that simultaneously shows the plurality of product allocation options, the depiction comparing income predicted to be derived from each of the plurality of product allocation options.

2. The computer-readable medium of claim 1, wherein the plurality of product allocation options including an option that includes both annuity and non-annuity products.

3. The computer-readable medium of claim 1, wherein the plurality of product allocation options are keyed to a predicted probability of success, and wherein the predicted probability of success is the same for each of the plurality of product allocation options.

4. The computer-readable medium of claim 1, wherein the plurality of product allocation options are keyed to a predicted legacy amount, the predicted legacy amount being a dollar amount that the retiree wishes to pass on as a legacy to beneficiaries, and wherein the predicted legacy amount is the same for each of the plurality of product allocation options.

5. A non-transitory computer-readable medium storing computer program code that, when executed by a computer, causes the computer to perform the operations of:
receiving information regarding retirement assets to be invested by a retiree planning for retirement;
selecting, based on the information received regarding retirement assets to be invested by the retiree, a plurality of product allocation options to present to the retiree, the product allocations comprising different allocations of the retirement assets to different types of products; and
generating one or more depictions showing predicted income for the retiree during a plurality of different phases of retirement, the one or more depictions including a depiction that simultaneously shows the plurality of product allocation options, the depiction comparing income predicted to be derived from each of the plurality of product allocation options during at least one of the phases of retirement.

6. The computer-readable medium of claim 5, wherein the plurality of product allocation options including an option that includes both annuity and non-annuity products.

7. The computer-readable medium of claim 5, wherein the plurality of product allocation options are keyed to a predicted probability of success, and wherein the predicted probability of success is the same for each of the plurality of product allocation options.

8. The computer-readable medium of claim 5, wherein the plurality of product allocation options are keyed to a predicted legacy amount, the predicted legacy amount being a dollar amount that the retiree wishes to pass on as a legacy to beneficiaries, and wherein the predicted legacy amount is the same for each of the plurality of product allocation options.

9. A non-transitory computer-readable medium storing computer program code that, when executed by a computer, causes the computer to perform the operations of:
receiving information regarding retirement assets to be invested by a retiree planning for retirement;
selecting, based on the information received regarding retirement assets to be invested by the retiree, a plurality of product allocation options to present to the retiree, the product allocations comprising different allocations of the retirement assets to different types of products; and
generating a depiction that simultaneously shows the plurality of product allocation options, the depiction comparing income predicted to be derived from each of the plurality of product allocation options, wherein, for each of the plurality of product allocation options, a range of incomes is shown.

10. The computer-readable medium of claim 9, wherein the plurality of product allocation options including an option that includes both annuity and non-annuity products.

11. The computer-readable medium of claim 9, wherein the plurality of product allocation options are keyed to a predicted probability of success, and wherein the predicted probability of success is the same for each of the plurality of product allocation options.

12. The computer-readable medium of claim 9, wherein the plurality of product allocation options are keyed to a predicted legacy amount, the predicted legacy amount being a dollar amount that the retiree wishes to pass on as a legacy to beneficiaries, and wherein the predicted legacy amount is the same for each of the plurality of product allocation options.

13. A non-transitory computerreadable medium storing computer program code that, when executed by a computer, causes the computer to perform the operations of:
receiving information regarding retirement assets to be invested by a retiree planning for retirement;
selecting, based on the information received regarding retirement assets to be invested by the retiree, a plurality of product allocation options to present to the retiree, the product allocations comprising different allocations of the retirement assets to different types of products, the plurality of product allocation options including an option that includes both annuity and non-annuity products, wherein the plurality of product allocation options are keyed to a predicted probability of success, wherein the predicted probability of success is the same for each of the plurality of product allocation options, wherein the plurality of product allocation options are keyed to a predicted legacy amount, the predicted legacy amount being a dollar amount that the retiree wishes to pass on as a legacy to beneficiaries, and wherein the predicted legacy amount is the same for each of the plurality of product allocation options; and
generating one or more depictions showing predicted income for the retiree during a plurality of different phases of retirement, the one or more depictions including a depiction that simultaneously shows the plurality of product allocation options, the depiction comparing income predicted to be derived from each of the plurality of product allocation options, wherein, for each of the plurality of product allocation options, a range of incomes is shown.

14. The computer-readable medium of claim 13, wherein the depiction further shows a comparison of the different allocations of the retirement assets to the different types of products for the plurality of product allocation options.

15. The computer-readable medium of claim 13, wherein the plurality of product allocation options are displayed in side-by-side fashion.

16. The computer-readable medium of claim 13, wherein the depicted income is an annual income.

17. The computer-readable medium of claim 13, wherein selecting the plurality of product allocation options comprises selecting the plurality of product allocation options from a database of pre-stored product allocation options based on the information received regarding retirement assets to be invested by the retiree.

18. The computer-readable medium of claim 13, wherein the computer program code, when executed by the computer, further causes the computer to perform the operation of receiving a selection of a desired probability of success, and wherein the predicted probability of success is the same as the desired probability of success.

19. The computer-readable medium of claim 13, wherein the retiree comprises a husband and wife.

20. The computer-readable medium of claim 13, wherein the retiree comprises an individual that is still working.

21. The computer-readable medium of claim 13, wherein the retiree comprises an individual that is retired.

22. The computer-readable medium of claim 13, wherein the depiction is generated in the form of at least one of a printout and an image on a computer display.

23. The computer-readable medium of claim 13, wherein the depiction compares an annual income goal of the retiree with a projected annual income associated with each of the plurality of product allocation options.

24. The computer-readable medium of claim 23, wherein the depiction comprises a graph that depicts a shortfall, if any, of the predicted annual income associated with one or more of the plurality of product allocation options relative to the annual income goal of the retiree.

25. The computer-readable medium of claim 23, wherein the annual income goal includes income to pay premiums for life insurance.

26. The computer-readable medium of claim 13, wherein the plurality of product allocation options include an option that comprises life insurance to fund at least part of the legacy goal.

27. The computer-readable medium of claim 13, wherein the depiction compares an essential needs income goal of the retiree with income derived from guaranteed income sources associated with each of the plurality of product allocation options.

28. The computer-readable medium of claim 13, wherein the essential needs income goal includes income to pay premiums for long term care insurance.

29. The computer-readable medium of claim 13, wherein the retirement assets to be invested is an amount estimated to be available to the retiree in the future.
